(19) United States
(12) Patent Application Publication
(10) Pub. No.: US 2006/0144860 A1
(43) Pub. Date: Jul. 6, 2006

(54) Two channel electronic temperature controller

(76) Inventors: Patrick J. O'Keefe JR., Wellington, OH (US); William C. Stumphauzer, Elyria, OH (US)

Correspondence Address: PAUL E MILLIKEN, 9061 WALL STREET, NW, MASSILLON, OH, 44646-1676, US

(21) Appl. No.: 11/324,623

(22) Filed: Jan. 3, 2006

Related U.S. Application Data
(60) Provisional application No. 60/640,302, filed on Jan. 3, 2005.

(51) Int. Cl. B67D 5/62

(52) U.S. Cl. 222/146.6

(57) ABSTRACT

A two channel electronic temperature controller for a gun for dispensing a hybrid plastisol hot melt adhesive that is flowable a room temperature. As the hot melt material is pumped under pressure from a supply source through a pre-heater and then through a gun having a gun heater, a first channel transmits signals from the electronic temperature controller which control the temperature of a pre-heater and a second channel from the electronic temperature controller transmits signals from the electronic temperature control which control the temperature of the gun heater and the pumping pressure. A sensor in the temperature controller detects when the pre-heater and gun heater are at a dispensing temperature or at a lower inactive temperature. When the gun is inactive for a predetermined time, a senses the inactivity and directs a control to reduce the temperature and shut off the pump. A reset switch in the temperature controller, when pressed, increases the temperature in the heaters to bring the hot melt material up to a suitable temperature for dispensing material from the gun and resumes the pressure upon the material.

### RELATED US APPLICATIONS

This is a non-provisional application of provision application Ser. No. 60/640,302 filed Jan. 3, 2005 and now pending.

### FIELD OF THE INVENTION

This invention relates to a temperature controller for a hybrid plastisol hot melt that is flowable at room temperature. This hot melt material must be raised to 280° F. to 350° F. to achieve its bonding properties.

### BACKGROUND OF THE INVENTION

A pump is used to bring the hot melt material at room temperature to a metallic heat exchanger that acts as a pre-heater for the material to bring it to temperature. The fluid then flows through a standard hot melt dispensing gun where the gun heater maintains the temperature of the material prior to being dispensed onto a substrate. The pre-heater and the dispensing gun each contain a cartridge heater that is powered by the electronics, and a temperature sensor that provides the value of the temperature to the controller.

Finally, the hybrid plastisol hot melt material degrades or solidifies in the supply hose if the material is under pressure from the pump at an elevated temperature for an extended period of time. Special logic is needed to drop the temperature back and relieve the pressure.

### OBJECTS OF THE INVENTION

One of the objects of this invention is to control the temperature of the heat exchanger and the dispensing gun

Another objective is to provide status of operation and diagnostics for both temperature channels.

Another objective of this invention is to prevent the hot melt material from degrading by providing a signal to release the pressure on the pump, and set the temperature back to a maintenance value, say 200° F. when the unit is not used for say 1 hour.

### BRIEF SUMMARY OF THE INVENTION

This invention is a two channel temperature controller that has the following features:
1.)Provides two channels of Proportional, Integral, Differential (RID) temperature control.
2.) Provides indication of open sensor, shorted sensor, Heater stuck on, Heater stuck off.
3.) Provides a signal to release the pressure on the pump, and set the temperature back to a maintenance value of approximately 200 F when the unit is not used for approximately 1 hour.

### BRIEF DESCRIPTION OF THE DRAWINGS

FIG. 1 is a diagrammatic view of an overview of the system;

FIG. 2 is a flow chart that describes the temperature control algorithm;

FIG. 3 is a flow chart of the sensor diagnostics logic;

FIG. 4 is a flow chart of the heater diagnostics logic;

FIG. 5 is a flow chart of the inactivity timeout logic;

FIG. 6 is a flow chart of the system ready reset logic; and

FIG. 7 is a block diagram of the electronics of the system.

### DETAILED DESCRIPTION OF THE INVENTION

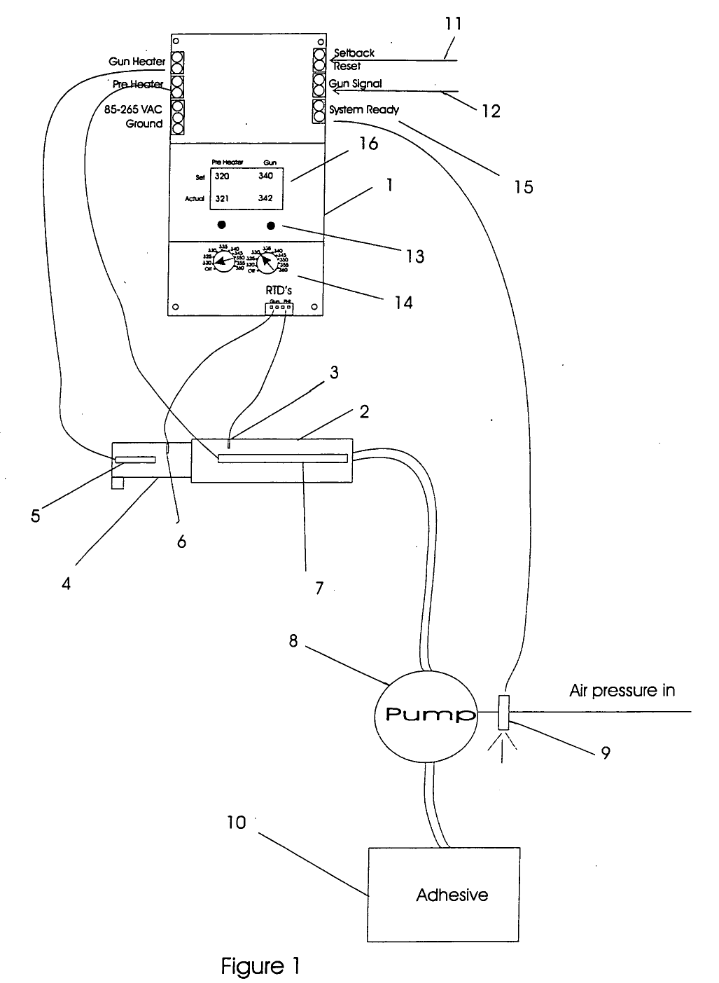

FIG. 1 shows the temperature controller in a typical system. The adhesive 10 is pumped 8 up to the pre-heater 2 and on to the dispensing gun 4. One channel of the temperature controller 1 is used to control the temperature of the pre-heater 2 using the temperature sensor 3 to determine when to apply power to the pre-heater heater 7. The gun channel similarly uses temperature sensor 6 to control the gun heater 5.

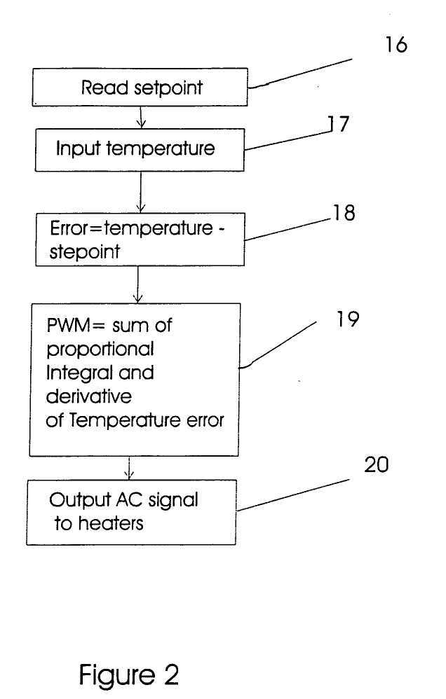

The purpose of the controller is to Control the temperature of two zones of temperature. The temperature set point is set between 320 and 360 Degrees Fahrenheit in 5 degree increments. These are set using a 10 position rotary switch 14 on the printed circuit board. Position “0” on this switch is used to disable the channel. A PID temperature control algorithm FIG. 2 is used to control the temperature.

The temperature controller 1 is at temperature when the temperature is within 1 degree F of the set point and continues to indicate at temperature on the LED 13 until the temperature drops approximately 14 degrees F below the set point. There is a gun signal input 12 to the board which provides a contact closure every time the gun fires. This input is used to sense inactivity of dispensing, and set the temperature back to 200 degrees F after 60 minutes of inactivity. There is a System ready relay contact that indicates; when the unit is at temperature, when there are no faults, and when the system is not in setback. The reset setback input 11 is intended for operator intervention to bring the unit out of setback after a period of inactivity. This input is designed to accept a contact closure.

A bicolor Red/Green LED 13 is mounted on the printed circuit board for each channel. The table below provides a summary of the operation of the LED's As the unit is coming up to temperature, both LED's 13 are lit providing a yellow color indication.

When the channel temperature is at the set point 14 temperature, the LED 13 is green.

If the unit is in Setback mode, the operator must provide a contact closure on the reset setback input 11. The fault conditions are cleared by correcting the fault. If there is a fault condition, the Red LED 13 blinks as indicated in the table below.

| Condition | State | LED code | Heater | System read |
|---|---|---|---|---|
| Temperature | Normal | LED not lit for | Disable | NA for this |
| channel off | operating | the channel | | channel |
| Under | Normal | Yellow | Active | 0pen |
| temperature | operating | | | |
| At ternperature | Normal | Green | Active | Closed |
| | operating | | | |
| Set back | Normal | Yellow Blinking | Disable | 0pen |
| | operating | | | |
| Open Sensor | Fault | 1 Red blink | Disable | 0pen |
| Fault | | | | |
| Shorted Sensor | Fault | 2 Red blinks | Disable | 0pen |
| Fault | | | | |
| Heater not on | Fault | 3 Red blinks | Disable | 0pen |
| Fault | | | | |
| Heater full on | Fault | 4 Red blinks | Attempt to | Open |
| Fault | | | Disable | |

The set point and actual temperatures for each channel are shown on the display 16.

The hot melt material degradation pressure relief and temperature setback logic is actuated by pneumatic solenoid 9, powered by the system ready solid state relay 15 when there has been no gun signal 12 for a period of time. The setback reset input 11 requires a contact closure button to bring the system out of setback once again controlling at the operational set point, and restoring pressure to the pump 8, 9.

Referring to FIG. 2, the temperature control algorithm flow diagram is shown. This is a standard Proportional Integral differential (PID) control algorithm The set point is read 16 from the switches 14, and the temperature is input 17 from the sensors 6, 3 and the error is calculated 18 between the set point and the actual temperature. The pulse width modulation 19 (PWM) is computed based on the sum of the above mentioned PID calculations, and the signal is sent to the solid state relays 41 and 45 to power the respective heaters 5,7.

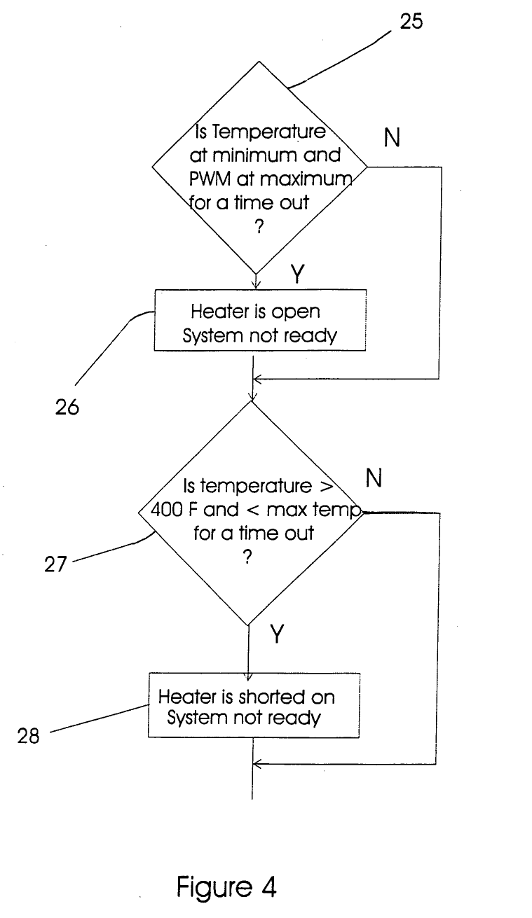

Referring to FIG. 4, the sensor fault diagnostics flow chart is shown in items 21 through 24. If the temperature measurement is at the maximum value 21 that is possible from the A to D converter 39, 47, then the sensor 3,6 is reading a measurement that is far above the normal operating range, and the sensor is determined to not be present or open circuited 22. The system is determined to be not ready 24, and the LED 13 diagnostic blink code is initiated.

Further referring to FIG. 4, if the temperature measurement is at an unusually low temperature outside of the normal operating range for the controller for a period of time that is beyond the normal warm up time for the channel 23, the sensor is determined to be short circuited 24, and the system is determined to be not ready, and the LED diagnostic blink code is initiated.

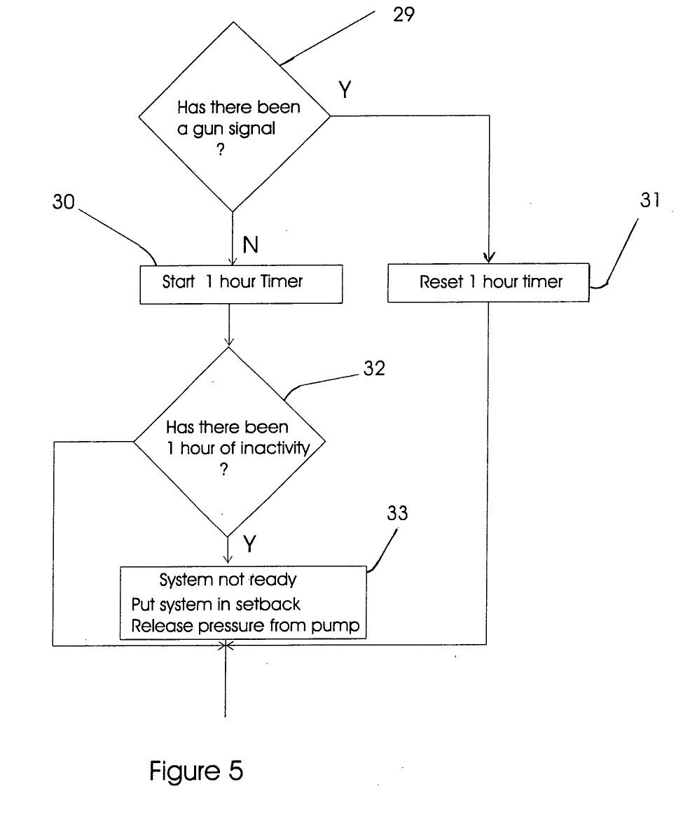

Referring to FIG. 5, the heater fault diagnostics flow chart is shown in items 25 through 28. If the temperature measurement is unusually low, but not low enough to be influenced by noise, and the PWM signal is at it's maximum asking for full heater power for a period of time that is outside of a normal warm up time for the channel 25, the heater is determined to be non functional or open, and the system is not ready 26, and the blinking diagnostics are initiated for that channel.

Further referring to FIG. 5, if the temperature is greater than 400° F. which is outside of the normal operating range for a given channel and also if the temperature is less than a maximum value for a given period of time that is beyond a normal operating or over shoot condition for a given channel 27, the heater is determined to be stuck on and the system is determined to be not ready 28, and the blinking diagnostics is initiated for that channel.

FIG. 5 is the flow chart for the material degradation logic. If there has not been a gun signal 29 for an hour 30, 32 the system is determined to be not ready, and the system is placed in setback, and the yellow flashing LED is initiated 33. If there is a gun signal within the hour, the timer is reset 31.

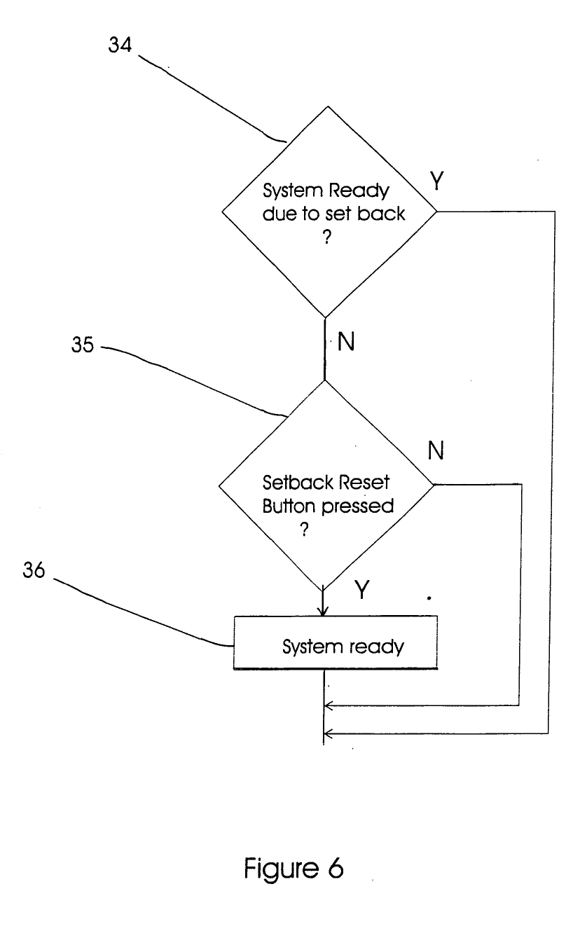

Referring to FIG. 6, if the system is not ready due to the system being placed into setback 34, the system is brought back into operation by a contact closure on 35 the reset setback 36 input on the controller.

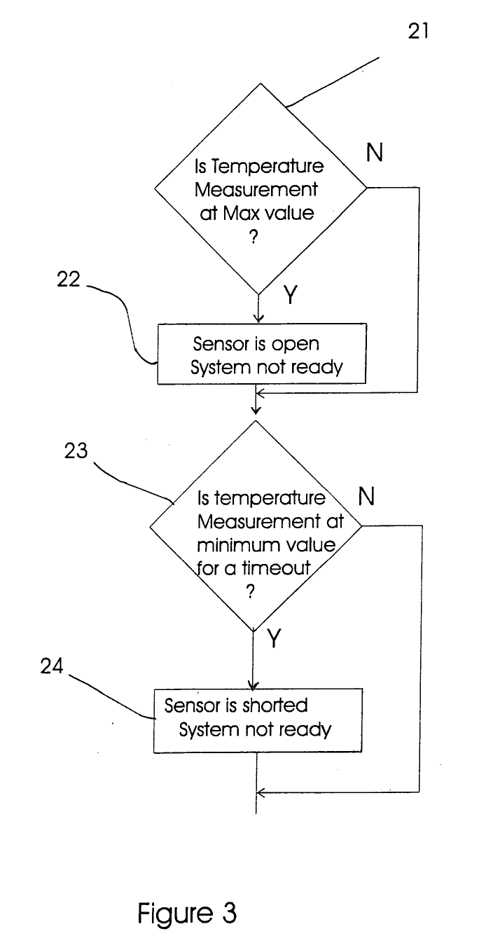

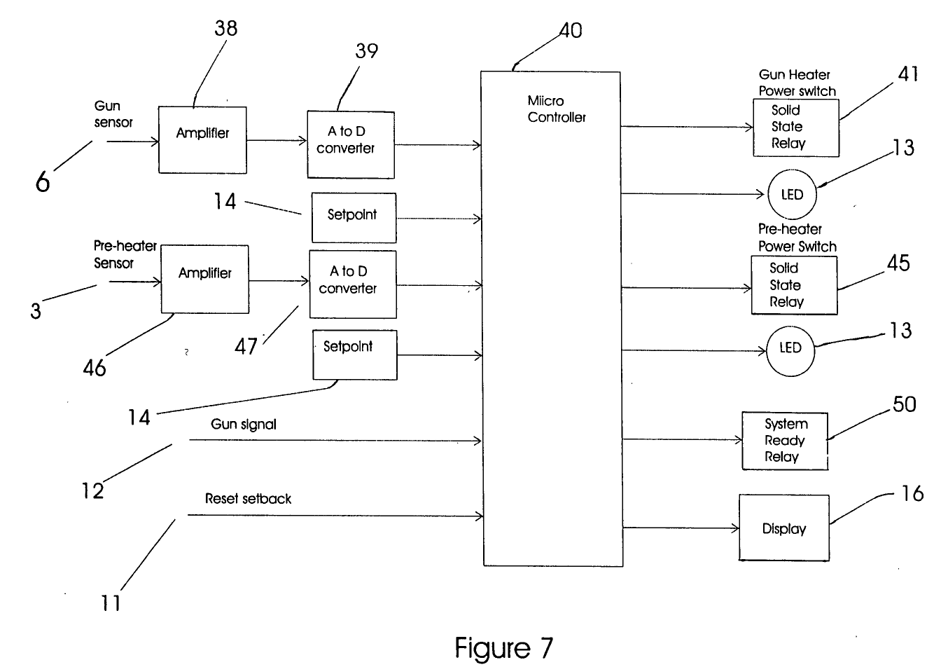

FIG. 7 shows the block diagram of the electronics design. The gun temperature sensor 6 is amplified and biased 38 and presented to the Analog to digital converter 39 which is then available to the microcontroller 40 to perform calculations. The temperature set point is input from a 10 position Binary coded decimal (BCD) switch 14. These are used to perform the operations described by FIGS. 2 through 6, and output the PWM power signal to the gun heater 5 on solid state relay 41, and provide diagnostics information on LED 13, provide set point and actual temperature information on the display 16, the gun signal is monitored 6 and the system ready signal is output 50 using a relay. Finally, the reset setback contact closure is monitored when the system is in setback due to inactivity.

A similar temperature control circuit exists for the pre-heater as well and illustrated by items 3, 7, 40, 45, 46, and 47.

What is claimed is:

1. A two channel electronic temperature controller for a gun for dispensing a hybrid plastisol hot melt material comprising:
A first channel for controlling the temperature of a pre-heater for hot melt material being supplied to the gun;
A second channel for controlling the temperature of a gun heater
means for maintaining a predetermined temperature of the hot melt material as is passes through the gun while being dispensed therefrom;
Means to maintain predetermined pressure on the hot material while the material is being dispensed from the gun;
means to sense a predetermined period of inactivity of the gun when no material is flowing though the gun;
means to reduce the temperature of the material and turn off the pressure on the material during inactivity of the gun;
means to reset the pre-heater and gun heater to increase the temperature of the hot melt material and to resume the pressure thereon to a suitable level for dispensing from the gun.

2. The temperature controller of claim 1, wherein the first channel receives signals from a temperature sensor in the pre-heater to determine when the temperature of the pre-heater needs to be adjusted to the desired range for either dispensing or inactivity.

3. The temperature controller of claim 1, wherein the second channel range for either dispensing or inactivity receives signals from a temperature sensor in the gun heater to determine when the temperature of the gun heater needs to be adjusted to the desired

4. The temperature controller of claim 1, wherein the temperature controller maintains a temperature range of 320° F. and 360° F. when the gun is dispensing the hot melt material.

5. The temperature controller of claim 1, wherein the temperature controller reduces the temperature of the hot melt material to 200° F. after a predetermined period of inactivity of the gun.

6. The temperature controller of claim 5 wherein the temperature controller reduces the temperature of the hot melt material after 60 minutes of inactivity.

7. A two channel electronic temperature controller and dispensing gun assembly for dispensing a hybrid plastisol hot melt material comprising:
a hot melt material source;
pressure means moving the hot material through a pre-heater and a gun heater when needed for dispensing by the gun;
A first channel for controlling the temperature of a pre-heater for hot melt material being supplied to the gun;
A second channel for controlling the temperature of a gun heater
means for maintaining a predetermined temperature of the hot melt material as is passes through the gun while being dispensed therefrom;
means to sense a predetermined period of inactivity of the gun when no material is flowing though the gun;
means to reduce the temperature of the material and turn off the pressure means during inactivity of the gun; and
means to reset the pre-heater and gun heater to increase the temperature of the material and to resume the pressure upon the material to a suitable level for dispensing from the gun.

8. The temperature controller of claim 7, wherein the first channel receives signals from a temperature sensor in the pre-heater to determine when the temperature of the pre-heater needs to be adjusted to the desired range for either dispensing or inactivity.

9. The temperature controller of claim 7, wherein the second channel range for either dispensing or inactivity receives signals from a temperature sensor in the gun heater to determine when the temperature of the gun heater needs to be adjusted to the desired

10. The temperature controller of claim 7, wherein the temperature controller maintains a temperature range of 320° F. and 360° F. when the gun is dispensing the hot melt material.

11. The temperature controller of claim 7, wherein the temperature controller reduces the temperature of the hot melt material to 200° F. after a predetermined period of inactivity of the gun.

12. The temperature controller of claim 11 wherein the temperature controller reduces the temperature of the hot melt material after 60 minutes of inactivity.
